(19) United States
(12) Patent Application Publication
(10) Pub. No.: US 2010/0099014 A1
(43) Pub. Date: Apr. 22, 2010

(54) SAFETY VALVE FOR BATTERY

(76) Inventors: Weixin Zheng, Shenzhen (CN); Jianhua Zhu, Shenzhen (CN); Xi Shen, Shenzhen (CN)

Correspondence Address: BRINKS HOFER GILSON & LIONE, P.O. BOX 10395, CHICAGO, IL, 60610, US

(21) Appl. No.: 12/530,334

(22) PCT Filed: Dec. 26, 2007
(86) PCT No.: PCT/CN2007/071337

§ 371 Date: Sep. 8, 2009

(30) Foreign Application Priority Data
Apr. 16, 2007 (CN) 200720119578.4

(51) Int. Cl. H01M 2/12; F16K 17/02

(52) U.S. Cl. 429/56; 429/53; 137/511

(57) ABSTRACT

A safety valve for battery has a valve body (1) and a valve core (2). The valve body (1) is fixed on a cover plate (4) of a battery and covers a discharging hole (9) in the cover plate (4) of the battery. The valve body (1) is formed with an exhaust opening (3) which is communicated with an internal space of the valve body (1). The valve core (2) is elastically held between a top cover (11) of the valve body (1) and the cover plate (4) of the battery. A plurality of columns (6) are arranged at intervals along a circumference of a gap between a side wall of the valve core (2) and an inner wall of the valve body (1). A cavity defined by every two adjacent columns (6), the side wall of the valve core (2) and the inner wall of the valve body (1) forms as a side exhaust slot (7) which is communicated with the exhaust opening (3) in the valve body (1).

### FIELD OF THE INVENTION

This present invention relates to the filed of battery, and more particularly to a safety valve for battery.

### BACKGROUND OF THE INVENTION

A secondary battery, such as a lithium ion battery, during the production and application, a great quantity of gases may be produced inside of the battery, if not discharged immediately, the battery may be swelled, and even exploded. Thus the battery must be provided with an explosion-proof device, such as a safety valve installed on a cover plate of the battery.

At present, a safety valve for battery mainly consists of a valve body and a valve core which is located in the valve body, an exhaust opening is formed in the valve body, the valve core closes a discharging hole in the cover plate of the battery. When a great quantity of gases is generated inside of the battery and a high pressure is formed in the same, the high pressure gases may burst the valve core, and pass through the discharging hole in the cover plate of the battery, and then be discharged from the exhaust opening in the valve body, so as to ensure the safety of the battery.

In order to reuse the safety valve on the battery, a recoverable safety valve for battery has been designed, that is, using a spring or a elastic metal sheet to elastically fix the valve core in the valve body, or using a elastic material to make the valve core, so that after the high pressure gases in the battery burst the valve core and be discharged from the exhaust opening in the valve body, the pressure inside of the valve body and battery is reduced, and under the action of elasticity, the valve core may automatically return to the position where the discharging hole in the cover plate of the battery may be closed by the valve core, thus the battery and the safety valve may continue to work.

However, in the recoverable safety valve for battery, when the valve core returns to its initial position, since under the action of the high pressure gases, the valve core may move transversely in the valve body, thus, the valve core can't accurately return to its initial position to close the discharging hole in the cover plate of the battery, thus the air tightness of the battery can't be guaranteed, the working performance of the battery shall be adversely influenced.

### SUMMARY OF THE INVENTION

This invention aims to provide a safety valve for battery with an accurately positioned valve core, suitable for repetitive operation and with a simple structure.

The safety valve for battery according to the present invention comprises a valve body fixed on a cover plate of a battery and covering a discharging hole in the cover plate of the battery, the valve body is formed with an exhaust opening which is communicated with an internal space of the valve body, and a valve core elastically held between a top cover of the valve body and the cover plate of the battery, wherein a plurality of columns are arranged at intervals along a circumference of a gap between a side wall of the valve core and an inner wall of the valve body, a cavity defined by every two adjacent columns, the side wall of the valve core and the inner wall of the valve body forms as a side exhaust slot which is communicated with the exhaust opening in the valve body.

The advantages of this invention: (1) the column structure between the inner wall of the valve body and the side wall of the valve core ensures that the valve core can be properly positioned between the top cover of the valve body and the cover plate of the battery; (2) since the valve core is made of elastic material and has a simple structure, under the action of gas pressure the valve core may accurately restore to its original state, that is, return to the position where the discharging hole in the cover plate of the battery may be closed by the valve core, so that the safety valve for battery can be used repeatedly; (3) with an annular protrusion arranged around the discharging hole in the cover plate of the battery, it may not only assist to position the valve core, but also ensure that the discharging hole in the cover plate of the battery can not be completely closed by the valve core, thus, when the valve core is pressed upward under the action of high pressure gases, the gas may easily escape from an gap between the annular protrusion and the valve core.

### BRIEF DESCRIPTION OF THE DRAWINGS

FIG. 1 is a schematic top view of the safety valve for battery according to the first embodiment of the present invention.

FIG. 2 is a sectional view taken along line A-A in FIG. 1.

FIG. 3 is a schematic sectional view of the safety valve for battery according to the second embodiment of the present invention.

FIG. 4 is a schematic perspective view of the valve body of the safety valve for battery according to the second embodiment of the present invention.

### DETAILED DESCRIPTION OF THE EMBODIMENTS

This invention will be further described in the following in combination with the drawings.

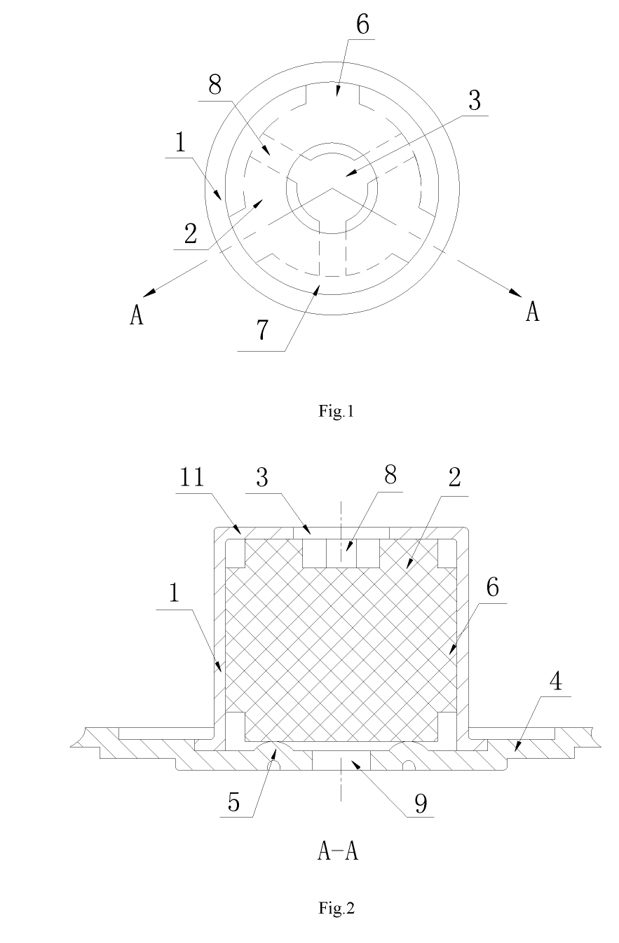

Referring to FIG. 1 and FIG. 2, the safety valve for battery according to the present invention comprises a valve body 1 and a valve core 2. Wherein the valve body 1 covers a discharging hole 9 in a cover plate 4 of the battery, and the valve body 1 and the cover plate 4 of the battery may be connected with each other by a various of connecting manners which are known to those skilled in the art, such as welding, adhering, and screw fastening etc. The valve body 1 is formed with an exhaust opening 3 in a top cover 11 thereof, which is communicated with an internal space of the valve body 1, preferably, the exhaust opening 3 is located at the center of the top cover 11 of the valve body 1. The valve core 2 is elastically arranged between the top cover 11 of the valve body 1 and the cover plate 4 of the battery, and the bottom of the valve core 2 closes the discharging hole 9. A plurality of columns 6 are arranged at intervals along a circumference of a gap between a side wall of the valve core 2 and an inner wall of the valve body 1. A cavity defined by every two adjacent columns 6, the side wall of the valve core 2, and the inner wall of the valve body 1 forms as a side exhaust slot 7 which is communicated with the exhaust opening 3 in the valve body 1. Preferably, an upper exhaust groove 8 which is located between every two adjacent columns 6 is formed at the top of the valve core 2. The communication between the side exhaust slot 7 and the exhaust opening 3 in the valve body 1 may be realized through the upper exhaust groove 8.

Preferably, the valve core 2 is made of elastic material (such as rubber or plastics). The top of the valve core 2 presses against the top cover 11 of the valve body 1, and the bottom of the valve core 2 tightly contacts with an annular protrusion 5 formed on the cover plate 4 of the battery. The annular protrusion 5 is arranged around the discharging hole 9 in the cover plate 4 of the battery.

The valve body 1 and the valve core 2 may be of various matched shapes, such as cylinder, prismoid etc., preferably both the valve body 1 and the valve core 2 are in shape of cylinder.

The columns 6 may be integral with the valve core 2 or be attached on the inner wall of the valve body 1. The quantity of the columns 6 may be determined as necessary, preferably, is 3 to 6.

In the case that the columns 6 are integral with the valve core 2, the height of the column 6 is 50-90% of that of the valve core 2, and its thickness is 2-15% of the diameter of the valve core 2, and its width is 5-15% of the perimeter of the valve core 2. The height of the annular protrusion 5 is 0.13-1.5 mm. The depth of the upper exhaust groove 8 is 10-20% of the height of the valve core 2, and its width is 2-15% of the perimeter of the valve core 2.

In the case that the columns 6 are attached on the inner wall of the valve body 1, the height of the column 6 equals to that of the valve body 1, and the thickness of the column 6 is 2-15% of the inner diameter of the valve body 1, and its width is 5-15% of the perimeter of the inner wall of the valve body 1. The height of the annular protrusion 5 is 0.1-1 mm. The depth of the upper exhaust groove 8 is 10-20% of the height of the valve core 2, and its width is 2-15% of the perimeter of the valve core 2.

In the following, the operating process of the safety valve for battery according to the present invention will be described.

When the battery is under normal operating conditions, the valve core 2 is in its original state, that is, the bottom of the valve core 2 tightly contacts with the annular protrusion 5 formed on the cover plate 4 of the battery, and thus the discharging hole 9 in the cover plate 4 of the battery is closed. The columns 6 are arranged between the side wall of the valve core 2 and the inner wall of the valve body 1, so as to properly position the valve core 2 inside of the valve body 1.

When the battery suffers an external compression or its operating temperature is very high, a great quantity of gas will be generated inside of the battery and producing a high pressure. The high pressure gas may lift the bottom of the valve core 2, so that the valve core 2 is compressed upwardly. Thus a gap is formed between the bottom of the valve core 2 and the annular protrusion 5, and the gas generated in the battery will be discharged out of the battery through the discharging hole 9 in the cover plate 4 of the battery, the side exhaust slot 7, the upper exhaust groove 8, and the exhaust opening 3 in the valve body 1 in turn. Therefore the pressure inside of the battery will be gradually reduced to the normal state. At this moment, the valve core 2 will release itself elastic force to ensure that the bottom of the valve core 2 can accurately restore to its original position to tightly contact with the annular protrusion 5. Thus the discharging hole 9 in the cover plate 4 of the battery will be properly sealed again, and the battery will restore to its normal operating conditions.

The safety valve for battery according to one embodiment of the present invention is shown as FIG. 1 and FIG. 2. Both the valve body 1 and the valve core 2 are in shape of cylinder, and the inner wall of the valve body 1 is smooth. Three columns 6 are integral with the valve core 2, and said three columns 6 are uniformly distributed on the side wall of the valve core 2. In order to ensure the strength of the valve core 2 and the exhaust efficiency, the height of the column 6 is 50-90% (preferred as 70%) of the height of the valve core 2, and its thickness is 2-15% (preferred as 8%) of the diameter of the valve core 2, and its width is 5-15% (preferred as 10%) of the perimeter of the valve core 2. The height of the annular protrusion 5 is 0.13-1.5 mm (preferred as 0.8 mm). The depth of the upper exhaust groove 8 is 10-20% (preferred as 15%) of the height of the valve core 2, and its width is 2-15% (preferred as 8%) of the perimeter of the valve core 2.

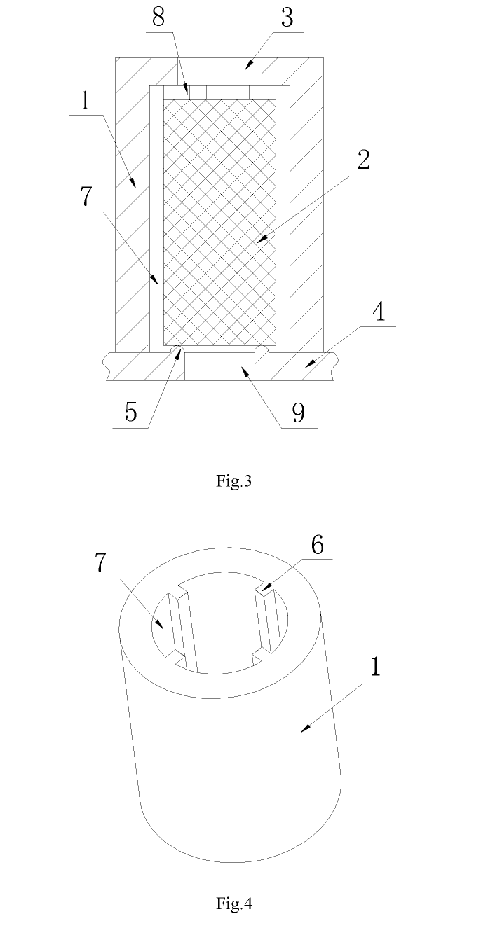

The safety valve for battery according to another embodiment of the present invention is shown as FIG. 3 and FIG. 4. Both the valve body 1 and the valve core 2 are in shape of cylinder, and the side wall of the valve core 2 is smooth. Four columns 6 are uniformly attached on the inner wall of the valve body 1. At this moment, the height of the column 6 equals to that of the valve body 1, the thickness of the column 6 is 2-15% (preferred as 8%) of the inner diameter of the valve body 1, and its width is 5-15% (preferred as 10%) of the perimeter of the inner wall of the valve body 1. The height of the annular protrusion 5 is 0.1-1 mm (preferred as 0.5 mm). The depth of the upper exhaust groove 8 is 10-20% (preferred as 15%) of the height of the valve core 2, and its width is 2-15% (preferred as 8%) of the perimeter of the valve core 2.

1-10. (canceled)

11. A safety valve for a battery, comprising:
a valve body disposed on a cover plate of a battery and covering a discharging hole in the cover plate of the battery, the valve body forming an internal space;
an exhaust opening disposed in the valve body, and in communication with the internal space of the valve body;
a valve core elastically held between a top cover of the valve body and the cover plate of the battery, the top cover being distal to the cover plate;
a side exhaust slot disposed between the side wall of the valve core and the inner wall of the valve body, and in communication with the exhaust opening in the valve body; and
an upper exhaust groove disposed at the top of the valve core, and in communication with both the side exhaust slot and the exhaust opening.

12. The safety valve for a battery as claimed in claim 11, wherein the valve core is made of an elastic material.

13. The safety valve for a battery as claimed in claim 11, wherein the top of the valve core engages the top cover of the valve body, and the bottom of the valve core closes the exhaust opening at a normal pressure.

14. The safety valve for a battery as claimed in claim 13, further comprising:
an annular protrusion formed on the cover plate of the battery, and disposed around the discharging hole in the cover plate of the battery.

15. The safety valve for a battery as claimed in claim 14, wherein the bottom of the valve core tightly contacts the annular protrusion, whereby closing the exhaust opening.

16. The safety valve for a battery as claimed in claim 11, wherein the exhaust opening is disposed at the center of the top cover of the valve body.

17. The safety valve for a battery as claimed in claim 11, wherein the depth of the upper exhaust groove is about 10-20% of the height of the valve core, and its width is about 2-15% of the perimeter of the valve core.

18. The safety valve for a battery as claimed in claim 11, wherein both the valve body and the valve core are cylindrical.

19. The safety valve for a battery as claimed in claim 11, further comprising:
a plurality of columns disposed at intervals between the side wall of the valve core and the inner wall of the valve body, wherein the cavity between two adjacent columns form the side exhaust slot.

20. The safety valve for a battery as claimed in claim 19, wherein the columns are integral with the valve core.

21. The safety valve for a battery as claimed in claim 19, wherein the height of the columns is about 50-90% of the height of the valve core.

22. The safety valve for a battery as claimed in claim 19, wherein the thickness of the columns is about 2-15% of the diameter of the valve core.

23. The safety valve for a battery as claimed in claim 19, wherein the width of the columns is about 5-15% of the perimeter of the valve core.

24. The safety valve for a battery as claimed in claim 19, wherein the columns are attached on the inner wall of the valve

25. The safety valve for a battery as claimed in claim 19, wherein the quantity of the columns is 3 to 6.

26. A safety valve for a battery, comprising:
a valve body disposed on a cover plate of a battery and covering a discharging hole in the cover plate of the battery, the valve body forming an internal space;
an exhaust opening disposed in the valve body, and in communication with the internal space of the valve body;
a valve core elastically disposed between a top cover of the valve body and the cover plate of the battery, the top cover being distal to the cover plate;
a side exhaust feature disposed between the side wall of the valve core and the inner wall of the valve body, and in communication with the exhaust opening in the valve body; and
an upper exhaust feature disposed at the top of the valve core, and in communication with both the side exhaust slot and the exhaust opening.

27. The safety valve for a battery as claimed in claim 26, wherein the top of the valve core engages the top cover of the valve body, and the bottom of the valve core closes the exhaust opening at a normal pressure.

28. The safety valve for a battery as claimed in claim 26, wherein the exhaust opening is disposed at the center of the top cover of the valve body.

29. A battery with a safety valve, comprising
a discharging hole on the battery;
a valve body forming an internal cavity and comprising an exhaust opening;
a valve core disposed within the internal cavity and elastically held in a position to close the discharging hole at a normal pressure;
at least one side exhaust slot defined between an internal surface of the valve body and the valve core; and
at least one radial exhaust groove in communication with the at least one side exhaust slot and the exhaust opening.

30. The battery as claimed in claim 29, wherein the valve core is made of an elastic material.
